(19) United States
(12) Patent Application Publication
(10) Pub. No.: US 2006/0003284 A1
(43) Pub. Date: Jan. 5, 2006

(54) Tooth whitening device

(76) Inventors: David William Sale, Heber Springs, AR (US); Ronald W. Haynes, Shirley, AR (US)

Correspondence Address: WILLIAM J. SAPONE;COLEMAN SUDOL SAPONE P.C., 714 COLORADO AVENUE, BRIDGE PORT, CT, 06605, US

(21) Appl. No.: 11/172,140

(22) Filed: Jun. 30, 2005

Related U.S. Application Data
(60) Provisional application No. 60/583,999, filed on Jun. 30, 2004.

(51) Int. Cl. A61C 3/00; A61C 5/00

(52) U.S. Cl. 433/29; 433/140; 433/215

(57) ABSTRACT

The invention is a locally mounted light source for light activation of tooth whitening compositions. A support in the form of a bridge attached to a retractor or as part of a mouth guard has integral therewith, a small and lightweight light source, such as could be provided by one or more high-intensity LED's, though other light sources could be used. The light source may be in the form of an array, powered by either a direct electrical connection to a power supply or by battery power, for example, with a battery pack worn by the user. The light source is thus located in proximity to the tooth surfaces regardless of head movement or orientation, increasing user mobility and comfort.

### CROSS REFERENCE TO RELATED APPLICATION

This application claims priority in U.S. Provisional application no. 60/583,999 filed Jun. 30, 2004.

### BACKGROUND

Tooth whitening in the dental office historically has been performed by using a hydrogen-peroxide gel applied to the teeth, which bleaches the tooth surfaces when activated by light. The light source is typically a large, floor or chair based light source.

There are several different gel products on the market, which are formulated so as to react to a specific wavelength and type of curing light being used, to activate the bleaching process. In most cases, the activation energy of the curing light is UV, heat, or laser. A recent addition to the list of light sources is a high intensity LED (Light Emitting Diode), which primarily emits blue light.

During an in-office dental whitening procedure, a patient is fitted with a dental retractor, which pulls back the lip tissue, to expose the upper and lower teeth to the light source. A wax-like material is applied to protect the gums from the effects of the gel and the light. The hydrogen-peroxide gel is then applied to the tooth surfaces.

Typically, the patient is then required to sit in the dental chair without moving for 20-30 minute segments while the light source is focused on the gel coated teeth. A full whitening treatment usually is composed of two or three segments, sometimes performed all in one day, though in other cases different segments are treated over multiple days. This is necessary to assure that the light has the proper angle to the tooth surfaces being activated. Of course, having to sit immobile for extended periods during bleaching can be very uncomfortable for the patient, and can ultimately detrimentally affect the process if the patient moves.

### SUMMARY OF THE INVENTION

It is an object of the present invention to simplify the tooth whitening process.

It is a further object to provide a tooth whitening process which is easier for the patient to tolerate over the extended periods required for light activated bleaching.

These and other objects of the present invention are achieved by providing a support in the form of a retractor having integral therewith, a small and lightweight light source, such as could be provided by one or more high-intensity LED's, though other light sources could be used. The light sources are attached directly to the retractor, possibly in the form of a light array. The array would be powered by either a direct electrical connection to a power supply or by battery power, for example, with a battery pack worn by the user.

By having a small, lightweight light source attached directly to the retractor, the light would, by default, always be focused correctly in all three axis onto the tooth surfaces, yet the patient would have the freedom to move during the procedure. With a wearable battery power supply, the patient would even be able to sit up or even walk around during activation.

Using an array with multiple, small light sources such as LED's, the focal length can be kept very short, preventing dangerous and uncomfortable stray light from reaching the patient's eyes, and allows focusing the energy in an arch shape quite easily, as compared to the prior single, high-powered light, which required a parabolic type reflector to properly focus the light around the arch. Having the light sources on the retractor, mounted to the mouth, or integral with a mouth guard mounted within the mouth also reduces the amount of lip and cheek extension, further increasing comfort for the user.

Preferably, the light source used would be substantially out of the patient's line of sight, lessening patient anxiety, as opposed to the typical large and imposing light source and support structure that normally fills the patient's view.

Being a small, relatively inexpensive light source, the light supporting retractor could also be adapted for the home tooth whitening market, which would include full whitening, or occasional follow-ups, or touch-ups. The inventive retractor could also be included as part of a home whitening kit that includes the gel and an applicator.

To reduce cost of a home product, one light source could be used instead of an array, which is preferred for dental office use. The single light source could additionally be movable on an arched track with multiple indentions to act as stops, so that the light source could be manually moved from one position to the next, in response to a timer or upon receiving an audio or visual signal from a controller or from the power source, to facilitate proper treating of each area of the full arch. This also reduces the size of the device, increasing user comfort.

Alternative methods for holding a small, portable light source may include a headband attachment, or other similar means to keep the light source focused correctly relative to the arch, regardless of the patient's head movements.

### BRIEF DESCRIPTION OF THE DRAWINGS

FIG. 1 is an illustrative view of the retractor of the present invention.

FIG. 1b is a side crossectional view of an embodiment having two rows of lights, which may each be selectively oriented.

FIG. 2 is a cross sectional view showing the retractor and light array relative to the teeth.

FIG. 3 is an alternative embodiment which includes an optional head support for holding the retractor in position.

FIG. 4 is an alternative embodiment which includes an optional chin and neck strap.

FIG. 5 is an alternative single source version adapted for home use.

FIG. 6 shows a mouth guard light support embodiment of the invention.

### DETAILED DESCRIPTION OF THE INVENTION

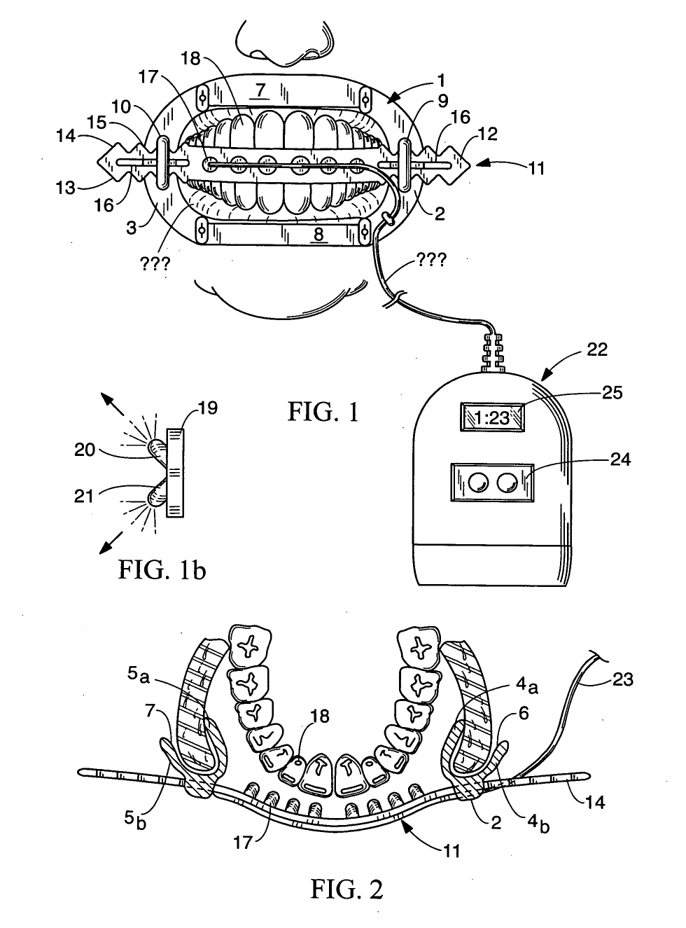

The present invention will be described relative to FIG. 1. A cheek or jaw retractor 1 has a pair of opposed curved arch portions 2 and 3. Each arch portion is composed of a pair of inner and outer walls, 4a, 4b and 5a, 5b, defining a lip receiving channel 6, 7, therebetween. These opposed arch portions are fitted to the mouth and lips which are spread apart to hold the mouth open, so that the cheek and lips remain retracted during the tooth whitening process. Lip protectors 7 and 8, having similar lip receiving channels, can be fitted over the upper and lower lip portions not received within the arched portions, to provide full lip protection, by shielding the lips from the whitening composition. These can be engaged in a snap fit with the opposed arch portions. All of these components may be made from any suitable resilient plastic material.

Each arched portion 2, 3 has a C-shaped support channel 9, 10 mounted on an outer surface of the outer wall thereof. These are positioned such that they are aligned in a parallel relationship. A bridge 11 is received in the pair of support channels, the bridge being movable within the channels. The bridge has a first end 12 and a second end 13, each end having means for engaging the corresponding channel support for temporary locking in a selected position. The bridge is thus adjustable, in that it can adapt to various opening sizes of the retractor. In FIG. 1, each bridge end has a pair of opposed serrated edges 14 that have a plurality of projections 15 that are engaged by the C shaped support channel. The serrations may be sloped in the outward direction, to facilitate enlarging the space between the supports, but to more firmly resist the tendency to lessen the space. Each end further has a longitudinal slot 16 coextensive with the length of serration, the slot providing a relief space so that the edges may be gripped and pressed together to release the serrations from the C-shaped support when the retractor is to be removed, or the bridge repositioned.

A plurality of light sources 17 are mounted to the bridge, facing inwardly, towards the teeth 18. Preferably from 1-10 light sources per row may be used. These can be any suitable light source for light activated tooth whitening. For example, these may be LED's, halogen or incandescent light bulbs, or other light delivery means, such as being fiber optic terminal ends. These light sources are preferably mounted along a longitudinal axis of the bridge, though this can vary depending on the desired location for light delivery. For example, a wider bridge 19 with upper and lower light sources 20, 21 may be used for directing light more specifically to the upper and lower teeth, as shown in FIG. 1b. Note that the lights themselves could also be oriented at various angles, to improve light distribution in the mouth. Virtually any suitable array and orientation of the light sources may be used.

A power supply 22 or a light source is remotely located and attached to the light sources by a cable 23. Preferably, battery power is used so that a battery pack can be worn by the user during the tooth whitening process. The power source has an on/off switch 24, and optionally includes a user settable timer 25 and optionally, audio, visual or other means to notify the user that sufficient time has elapsed so that the retractor may be removed.

Referring to FIG. 2, the retractor mounted on the mouth is shown in cross section. This shows the light sources 17 in proximity to the teeth 18, the retractor holding the cheeks 26 away from the tooth surfaces so that light activated whitening can be effectively achieved.

In use, the retractor would be fitted to the user and a gum protective coating applied. The whitener would then be applied to the tooth surfaces. The bridge would then be added by slipping the serrated ends into the C-shaped supports. The power supply would be connected to the bridge, and if a portable battery pack, given to the user to wear, for example on a belt. The timer would be set, and the lights powered to begin the activation process.

Since the user is not restricted by a fixed light source, the user has sufficient mobility to move about, sit up for comfort or to read, etc, during the activation process. After the process is complete, the retractor, bridge, lip protectors, etc, are disposed of, and only the power supply is reused.

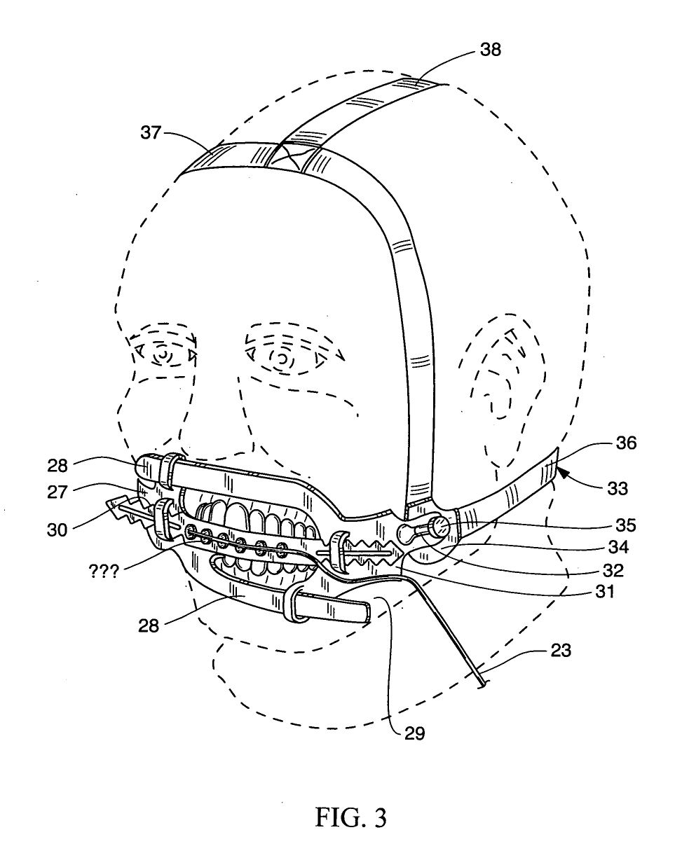

Referring to FIG. 3, an alternative embodiment of the present invention is shown. In this embodiment, a retractor 27 has means for engaging a support worn on the head, to increase stability, as well as integral lip protectors 28. Each arch portion 29, 30 has an extension 31 which lays on the outer cheeks. Each extension 31 has a slot 32 in its terminal end. A head support 33 has a base junction 34 with an upwardly projecting post 35, the post engaging the slots in the extensions. The head support has a resilient neck strap 36, which passes around the back of the neck to the opposed base junction with a corresponding upward post for engaging with the slot in the extension on the opposed arch portion. The head support also includes a resilient band 37 which passes over the top of the head, mating with a perpendicular resilient strap 38 which extends rearward and down to engage the neck strap at the back of the neck. The head support assures that head movements won't disturb the orientation of the light sources during the activation process, which additionally allows greater mobility of the user.

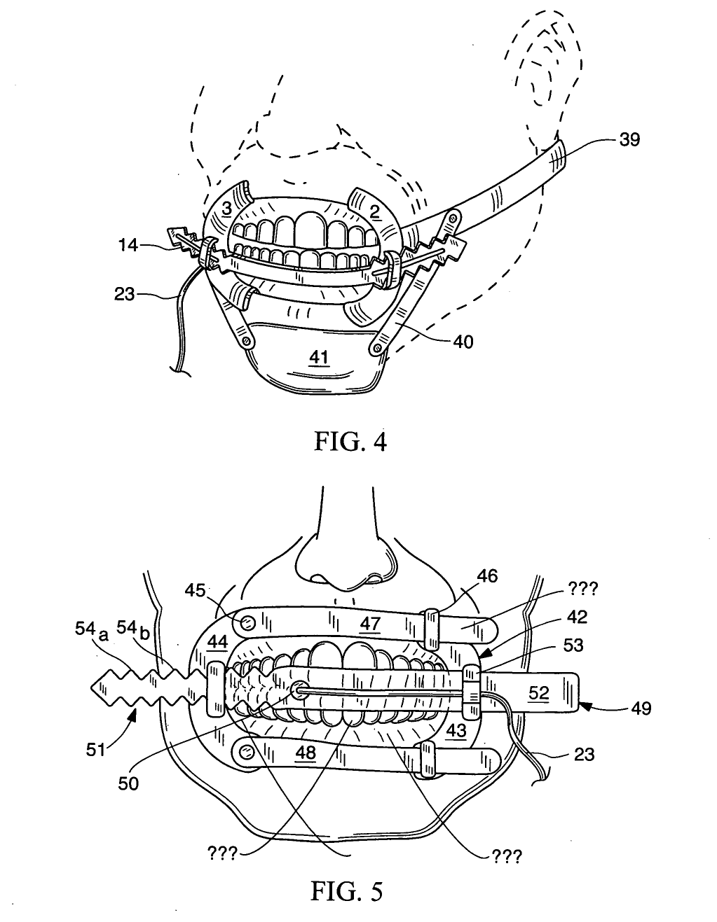

Referring to FIG. 4, another alternative embodiment of the invention also uses a resilient neck strap 39 that passes around the neck, but instead of the head straps, uses instead a chin strap 40 with a chin receiving pocket 41 to increase stability.

Referring to FIG. 5, an alternative embodiment of the present invention has a retractor 42 having a pair of opposed arch portions 43, 44. One arch portion has a pair of extending pegs 45, the other has a pair of slots 46. Two lip protectors 47, 48 are mounted to the arch portions, each lip protector having an opening for engaging a peg on one end thereof, the opposed end received in the corresponding slot. The bridge 49 in this embodiment differs, as it includes only one light source 50, and one serrated end 51, the other end 52 being unrestrained within its receiving c-shaped support 53. This end may have gripping means to facilitate hand engagement. This embodiment allows slidable repositioning of the light source to target different tooth surface areas. Preferably, the serrated edges of the bridge end have projections 54a, 54b spaced apart for about the distance between adjacent teeth, so that each engagement aligns the light source with a different tooth as the bridge is moved along its longitudinal axis. This embodiment is more suited to home use.

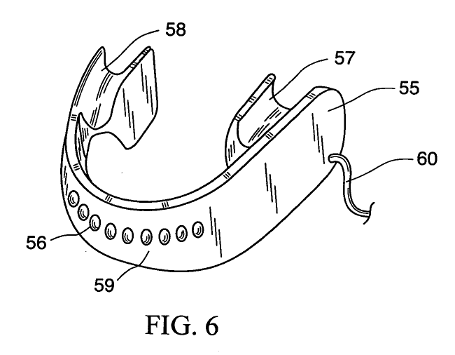

Referring to FIG. 6, an alternative embodiment of the present invention is shown. In this embodiment, a mouth guard 55 is used in place of a retractor. In this embodiment, after the tooth whitening material is applied, the mouth guard is inserted into the mouth. The mouth guard has a plurality of light sources 56 integral therewith. The mouth guard has a pair or rearwardly disposed tooth gripping passages 57, 58 that allow the user to close the teeth to hold the guard in place. A front wall 59 of the guard being of sufficient width to cover the tooth surfaces receiving the whitening composition to prevent lip contact, the forward wall having the light sources embedded therein being spaced away from the tooth surfaces when the guard is gripped by the teeth, to provide a light passage channel between the forward wall and the teeth. As with the other embodiments, a cable 60 leads to a power source for the light sources as described above.

This embodiment has the advantage that the lips to not need to remain retracted during activation, further increasing the comfort and mobility of the user. Of course, the above variations in light arrays, type of lights, power or light sources, etc. apply as well to this embodiment. In addition, as with all these embodiments, various optical enhancements, such as the use of lenses with the light source can be incorporated into the bridge, support or the light itself to enhance effectiveness. For example, a lens could improve light distribution to the angled tooth surfaces.

While preferred embodiments of the present invention have been shown and described, it will be understood by those skilled in the art that various changes or modifications can be made without varying from the scope of the invention.

What is claimed is:

1. A tooth whitening device for use in activating a light sensitive tooth whitening agent applied to at least one tooth comprising: a bridge for supporting at least one light source; a support for locating the bridge on or in the mouth in proximity to a surface of the tooth, and means to supply power to the light source.

2. The tooth whitening device according to claim 1 wherein the support comprises a cheek retractor.

3. The tooth whitening device according to claim 2 wherein the cheek retractor comprises a pair of opposed arched portions having lip receiving chamber, and having means for mounting the bridge thereto.

4. The tooth whitening device according to claim 3 further comprising lip protectors mounted between the opposed arch portions.

5. The tooth whitening device according to claim 1 wherein the bridge is removably mounted to the support.

6. The tooth whitening device according to claim 1 wherein the bridge is movably mounted to the support for adjusting the position of the light source relative to the tooth surface.

7. The tooth whitening device according to claim 1 wherein the power supply is a battery power supply.

8. The tooth whitening device according to claim 1 further comprising a head brace engaged to the support for stabilizing the location of the bridge.

9. The tooth whitening device according to claim 1 further comprising a neck and chin brace engaged to the support for stabilizing the location of the bridge.

10. The tooth whitening device according to claim 1 wherein the light sources is a plurality of light sources arranged in an array on the bridge.

11. The tooth whitening device according to claim 1 wherein the light source is a plurality of light sources arranged in a one or more rows arranged on the bridge.

12. The tooth whitening device according to claim 1 wherein the support is a mouth guard having tooth engaging surfaces, a front wall of the mouth guard having the light source integral therewith, the front wall spaced slightly away from the tooth surface.

13. The tooth whitening device according to claim 1 wherein the light source is selected from the group consisting of light emitting diodes, halogen lamps, incandescent lamps, fiber optic ends and combinations thereof.

14. The tooth whitening device of claim 1 wherein the power source has a timer for halting the power to the light source after a predetermined time and optionally has indicator means for alerting that the predetermined time has elapsed.

15. A method for whitening teeth comprising: applying a light sensitive whitening agent to the teeth, placing a tooth whitening device in the mouth having a bridge for supporting at least one light source; a support for locating the bridge on or in the mouth in proximity to a surface of the teeth, and means to supply power to the light source, and, powering the light source and maintaining light on the teeth for a predetermined time.

16. The method of claim 15 wherein the power supply is a battery power supply, and further comprising locating the power source on the person so as to increase mobility and comfort.

17. The method of claim 15 further comprising providing the power means with a settable timer for halting light application after the predetermined time.

18. The method according to claim 15 wherein the support is a mouth guard having tooth engaging surfaces, a front wall of the mouth guard having the light source integral therewith, the front wall spaced slightly away from the tooth surface, and, allowing the user to close the mouth during the light application.
